(19) United States
(12) Patent Application Publication
(10) Pub. No.: US 2025/0243973 A1
(43) Pub. Date: Jul. 31, 2025

(54) SPRAY BOTTLE HANGING DEVICE

(71) Applicant: The Epiphany Brand, Cincinnati, OH (US)

(72) Inventor: Tyler Collishaw, Cincinnati, OH (US)

(21) Appl. No.: 19/034,055

(22) Filed: Jan. 22, 2025

Related U.S. Application Data
(60) Provisional application No. 63/625,086, filed on Jan. 25, 2024.

(51) Int. Cl. F16M 13/02

(52) U.S. Cl. CPC F16M 13/022

(57) ABSTRACT

The present disclosure teaches a spray bottle hanging device that overcomes the problem of spray bottles produced without a convenient way to be stored in a hanging configuration. The hanging device includes a neck portion, an attachment feature, and a coupling mechanism. The neck portion and attachment feature ensure that the device may be able to hang from the desired location, and the coupling mechanism ensures that the hook and neck portion may stay attached to the head and body of the spray bottle during storage.

### TECHNICAL FIELD

Disclosed embodiments relate to the field of hangers and, in particular, to hangers affixed to spray bottles for storage.

### BACKGROUND

Many liquid products are commercially available to consumers in spray bottles. The spraying capability allows for easy dispersal of the fluid contained inside bottle without the need to constantly take a bottle cap on and off. Spray bottle containers are the typical packaging solution for cleaning products, freshening solutions, lubricants, and the like.

However, a common issue with the storage of spray bottles is a lack of space available on flat surfaces to stow the bottle. Users would often prefer to use the space available on flat surfaces for the storage of the items being used constantly, as opposed to the spray bottle items which may be used less frequently. Therefore, alternative modes of storage for spray bottles are valuable developments in the field.

One area of possible development is attachable mechanisms for hanging spray bottles in many different contexts. Due to the widespread use of spray bottles, the potential usefulness of mechanisms with which to hang those bottles is vast. Potential applications in which a hanging mechanism may be useful include hanging from hooks on a work bench, from a pegboard, from the wall of a garage, from a shower curtain rod, on hooks inside a locker, from the side of a flat shelf, on a coat hanger, on a gym machine, on a towel ring, on door handles, from a curtain, on an automobile grab handle, from a drawer handle, from wired shelving in a pantry, or similar modes disposed to hanging solutions. These potential solutions vary widely, and therefore several kinds of hanging mechanisms must be available. Thus, creating many different embodiments of a hanging mechanism which may be affixed to the spray bottle is an effective solution to the problem of limited storage space. Instead of sitting on a flat surface and taking up the limited area available in such a space, a hanging solution provides a simple and effective way to store the bottle.

### SUMMARY

This disclosure considers the need for a spray bottle with a hanger fixed to the bottle, the hanger being collapsible or small enough that the hanger does not impair the user's ability to easily store the spray bottle. The several embodiments disclosed concern ease of storage and attachment of implements for hanging the spray bottle device. This disclosure may enhance the commercial viability of spray bottles by providing spray bottles which can be easily hung from convenient locations by a built-in hook.

The disclosed embodiments include hooks attachable by a rounded ring fastener which may be tightened around the skirt of the of the spray bottle. Another variety of embodiments disclosed includes a hanger attached to the spray bottle inside the spray mechanism of the head. Another variety of hanging mechanisms disclosed includes hangers attached to the outer features of the head of the spray bottle. This disclosure includes variations on the hook piece to accommodate hanging in ways that could not otherwise be accomplished by the hook alone.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a perspective view of an attachable hook embodiment with a rounded ring fastener;

FIG. 2 is a view of a sprayer head with a gap in the trigger design for the hanger to snap in;

FIG. 3 is a view of a sprayer head with an elongated trigger piece;

FIG. 4 is a view of a flairosol head with a hook attached by a strut clip;

FIG. 5 is a view of a sprayer head with a shark fin hook attached by clipping around the nozzle;

FIG. 6 is a front view of a sprayer head with a shark fin hook exemplifying the nozzle clip mechanism;

FIG. 7 is a view of an open-face sprayer head with a hanger clipped into the mechanism;

FIG. 8 is a view of a sprayer head with a hanger locked into a hole in the back of the sprayer head;

FIG. 9 is a view of a sprayer head with a hanger extending at an angle and attached by a rounded ring fastener;

FIG. 10 is a view of an exemplary hanger with adhesive on the hook to assist in hanging;

FIG. 11 is a view of an exemplary hanger with a suction cup attachment on the side of the hook;

FIG. 12 is a view of an exemplary hanger with a cylindrical leg attachment on the side of the hook for hanging on pegboards;

FIG. 13 is a view of an exemplary hanger with a round hole leg attachment on the side of the hook for hanging on other hooks or wires;

FIG. 14 is an exemplary miniature hook for supporting smaller bottles while taking up less space;

FIG. 15 is an exemplary hook with an extended neck to accommodate for specific storage issues;

FIG. 16 is an exemplary hook with a carabiner attachment to hang in transport;

FIG. 17 is an exemplary square hook for hanging from flat surfaces;

FIG. 18 is an exemplary magnetic snap-on hook which changes shape and latches when it comes in contact with the surface;

FIG. 19 is an exemplary crocodile fabric clip attachable with a rounded ring fastener.

### DETAILED DESCRIPTION

In the following detailed description, reference is made to the accompanying

drawings which form a part hereof wherein like numerals designate like parts throughout, and in which is shown by way of illustration embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The challenges that the present disclosure set out to overcome are to provide a hanger device for a spray bottle with a round clip attachment mechanism; a hanger attachment within the spray bottle head mechanism; a hanger attachment fixable to the outer features of the spray head mechanism; and variations of those hanger devices and attachments to accommodate additional hanging use cases.

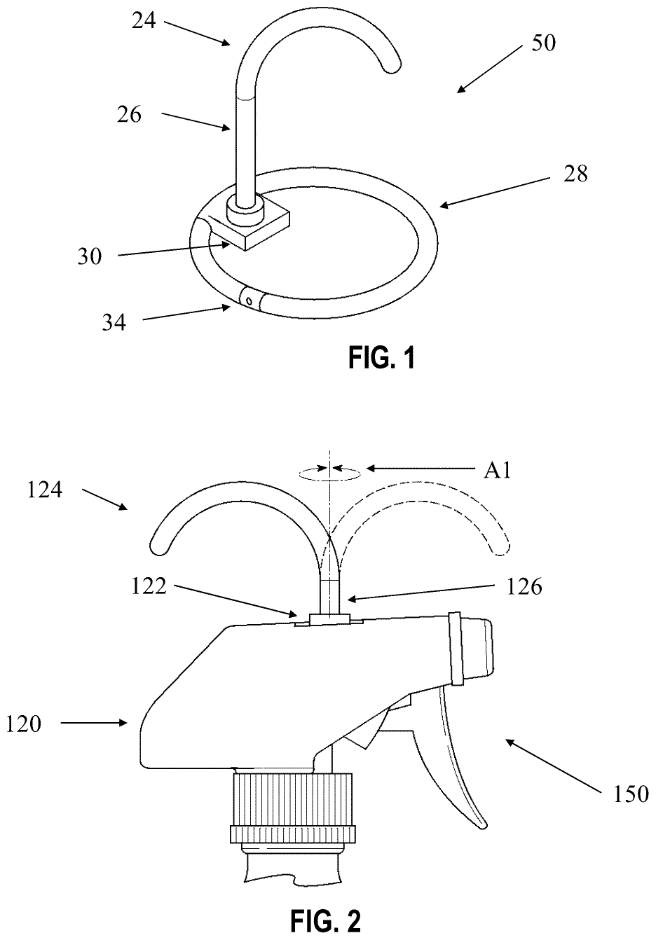

FIG. 1 shows a partial perspective view of an embodiment of a spray bottle 50. Embodiments of the spray bottle 50 in accordance with versions described herein can be hung, attached, selectively detachable, or can otherwise be coupled with a door, towel, shower rod or other bathroom fixture, pegboard, curtain, work bench, handle, coat hanger, desk, wire shelving, or other similar articles to provide easy access to a disinfecting compound. Towels and other bathroom articles can retain and incubate bacteria, viruses, molds, pathogens, and/or other undesirable compounds or materials. Many users do not wash a towel after each use, where it may be common for a moist article to be stored in a dark environment repeatedly, making it the perfect growth condition for pathogens and the like. It may also be economically detrimental to wash an article after each use. It may therefore be beneficial to provide a bathroom article treatment composition in close proximity to the article itself.

The spray bottle 50, in accordance with versions described herein, can include an attachment feature 24, such as a hook, suction cup, magnet, tongue and loop fastener, or any other suitable fastener, that allows the spray bottle 50 to be positioned adjacent an article such as a towel. The spray bottle 50 can include any suitable composition, such as for example, a desiccant, an antibacterial, an antimicrobial, an antifungal, and antipathogen, and/or any other suitable material alone or in combination.

Referring to FIG. 1, the spray bottle 50 can include the attachment feature 24 in the form of a hook member. The attachment feature 24 may be attached to a neck member 26 of the spray bottle 50. The attachment feature 24 and the neck member 26 may be a cohesive unit, requiring no mechanical coupling to remain attached. The neck member 26 may provide space between the attachment feature 24 and the body of the spray bottle 50 for improving how easily the embodiment may hang. The neck member 26 may be in turn connected to a rounded ring fastener 28 by coupling the end of the neck member 26 to a connector portion 30 of the rounded ring fastener 28. The neck member 26 may be attached to the connector portion 30 by being molded into a single cohesive body with no need for coupling of the pieces. The rounded ring fastener 28 serves to attach the embodiment to the skirt portion (not shown) of a spray bottle 50 by tightening and locking to itself with the plastic clip button fastener 34.

The embodiment presented in FIG. 1 may increase the ease of storage of spray bottles. The rounded ring fastener 28 may be easily attached to and detached from the skirt portion 32 of a spray bottle to enable a user to choose whether to give the spray bottle a hanging function based on their need. Further, the inobtrusive size and design of the embodiment may allow for ease of use of the spray function while still attached to the bottle, as well as allowing for continued storage besides hanging due to not significantly increasing the size of the spray bottle when the device is attached.

FIG. 2 shows a partial perspective view of a spray bottle 150. Embodiments of the spray bottle 150 in accordance with versions described herein may hang from attachment feature 124 embedded within the spray bottle 150. This embodiment includes a sprayer head 120 with a gap 122 in the top. The gap 122 may accept the neck member 126 to extend into the sprayer head 128 and attach within the sprayer mechanism (not shown). Attachment within the sprayer head 128 may better assure fixation of the attachment feature 124 to the spray bottle 150. The attachment feature 124 in FIG. 2 may be rotatable around the vertical axis centered on the neck member 126 such that the attachment feature 124 has 360 degrees of rotation to accommodate any hanging position, as shown by arrow A1.

Embedding the device into the sprayer head 128 as disclosed in FIG. 2 may serve to grant stability to the spray bottle while hanging. This embodiment may be especially useful for use cases in which the spray bottle is especially large, or the load to be carried is otherwise heavier than what may otherwise be needed. In those cases, the attachment feature 124 embedded in the sprayer head 128 may serve to hold more weight in the spray bottle without failure that may occur in other hanging spray bottle solutions.

The rotating capability of the neck member 126 and attachment feature 124 disclosed in FIG. 2 serves to provide more flexible storage capacity as may be required by the user. Because many spray bottles are asymmetrical, the most advantageous orientation of storing the spray bottle may vary based on the storage location and the surroundings of the spray bottle. A rotating neck member 126 and attachment feature 124 may provide flexibility in those situations so that the user may orient the spray bottle to best fit each location. The rotating capability also serves a convenience function by allowing the spray bottle to be rotated after the device is already hanging. For example, if the user hung the bottle in one orientation but wishes to pick it back up in the opposite orientation with one hand, instead of picking the bottle up in the orientation it was placed and putting it down so the user can then turn it on a surface, the user may be able to turn the spray bottle as it hangs, then grab it in the preferred orientation.

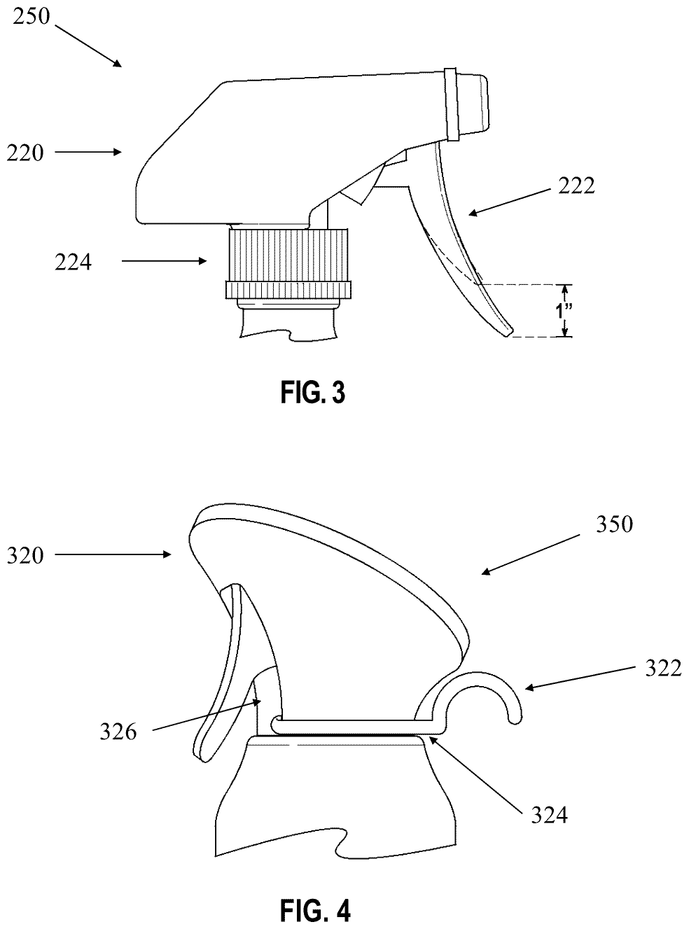

FIG. 3 shows a partial perspective view of a spray bottle 250. This embodiment includes a sprayer head 220 with a trigger piece 222 elongated by about 1 inch to about six inches. In one or more embodiments, the trigger piece 222 may be elongated by about 1 inch to about 4 inches, from about 1 inch to about 2.5 inches, or from about 1 inch to about 2 inches. In yet another embodiment, the trigger piece 222 may be elongated by about 1 inch. The elongated trigger piece 222 serves to allow for improved spray experience by accommodating all four fingers of the user to be used when pulling to spray. The elongated trigger piece 222 also serves a similar function as the attachment features 24 and 124 from FIG. 1 and FIG. 2 respectively: to allow the gap between the trigger piece 222 and the skirt portion 224 to serve as a makeshift hook by which the spray bottle can easily hang.

The embodiment disclosed in FIG. 3 with the elongated trigger piece 222 may serve to provide a hanging mechanism to the user despite not carrying the appearance of such a mechanism. In some cases, a user may not want to purchase a spray bottle with an extra mechanism attached that is clearly meant for hanging the bottle. In those cases, the elongated trigger piece 222 may still serve to provide the user with the possibility of flexible storage solutions. Because traditional trigger mechanisms are quite short, they can prove untenable or unreliable mechanisms from which the spray bottle may hang, especially in cases of heavy spray bottles. Providing an elongated trigger piece 222 therefore may solve one problem with hanging a spray bottle by the trigger piece. Because the elongated trigger piece 222 may have sufficient length, the user may hang the spray bottle with less chance of it falling from the hanging position. The elongated trigger piece 222 also may serve to provide more flexibility in hanging positioning over a traditional trigger piece. In order for a spray bottle to properly hang from the trigger piece, the trigger piece 222 must extend sufficiently far past the structure from which the spray bottle 250 hangs, or else the spray bottle 250 will hang too precariously and will be likely to fall from the hanging position with only a slight disturbance. Therefore, the elongated trigger piece 222 may extend far beyond the structure from which the spray bottle 250 hangs, so it may allow for more secure storage of a spray bottle.

The elongated trigger piece 222 in FIG. 3 may also provide an ergonomic advantage by providing space for all four fingers of the user to be placed on the trigger piece. Traditional trigger mechanisms are often too short for users to squeeze them with all four fingers. This presents problems such as tendon discomfort from consistent flexion of only a portion of the user's fingers, or even fatigue of those fingers being overworked. Therefore, the elongated trigger piece 222 may solve the problems of wrist and hand pain and fatigue by allowing the use of all four of the user's fingers in unison, which may both remove tendon pain from the divided finger movements and provide a less fatiguing experience by dividing the strain of pulling the trigger mechanism.

FIG. 4 shows a partial perspective view of a flairosol spray bottle 350. This embodiment includes a flairosol head 320 with an attachment feature 322 attached by a strut clip 324. The attachment feature 322 may be attached to the flairosol head 320 by the strut clip 324 straddling the base of the flairosol head 320 symmetrically on both sides and by entering the recess 326 of the flairosol head 320 to attach to the mechanism (not shown) inside. The strut clip 324 serves to provide necessary stability to hang the flairosol spray bottle 350 despite the shallow recess 326 typical of a flairosol spray bottle 350. Because a flairosol spray bottle 350 has fewer options for the attachment feature 322 to be coupled, the strut clip 324 may serve the important purpose of providing an anchor for the attachment feature 322 to be adequately connected to the flairosol head 320.

The embodiment disclosed in FIG. 4 with the attachment feature 320 attached by a strut clip 324 to a flairosol head 320 may serve to allow any kind of spray bottle with a flairosol head to benefit from the same hanging solutions as those provided to traditional sprayer heads. With the recently emergent flairosol head, many spray bottles have different head mechanisms and shapes from the traditional sprayer heads. Further, the unintrusive design of the rear hook takes up little space and may therefore allow the user to continue to store the spray bottle in otherwise tight spaces. The rear hook also may allow the spray bottle to be stored by hanging against a wall, using the weight of the bottle and its contents as a counterbalance to keep the bottle in place, instead of relying only on gravity.

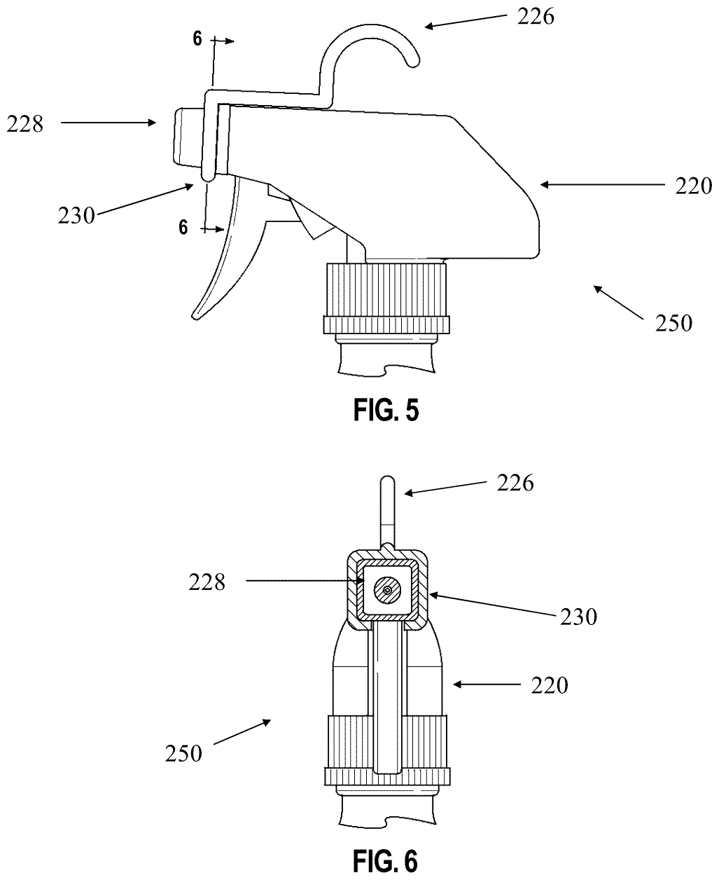

FIG. 5 and FIG. 6 show a partial perspective side view and a front view, respectively, of a spray bottle 250. These embodiments include the sprayer head 220 with an attachment feature 224 in the shark fin hook 226 configuration attached to the spray bottle 250 by being secured around the nozzle 228. From where the arms 230 may be secured to the nozzle 228, a neck member 232 may run along the middle of the top plane of the sprayer head 220 to the shark fin hook 226. The arms 230, neck member 232, and shark fin hook 226 may constitute a single continuous body. The shark fin hook 226 may be held in place by its arms 230 hugging and clipping around the bottom of the nozzle 226. The shark fin hook 226 may be detachable by unclipping its arms 230 from the nozzle 228, so that the nozzle 228 can be rotated if it can be so configured.

The shark fin hook 226 embodiment may serve to provide the user with a simple and effective detachable hanging solution for spray bottles with traditional sprayer head shapes. The shark fin hook 226 may fit snugly to the top of the sprayer head 220 and protrude only slightly over the top to provide an unobtrusive option, allowing for flexible storage options when stored in ways other than hanging. The detachable nature of this embodiment may also lend flexibility to the users such that if the user does not wish to leave the shark fin hook 226 attached when not hanging the spray bottle, it can be easily detached by unclipping the arms 230 from the nozzle 228.

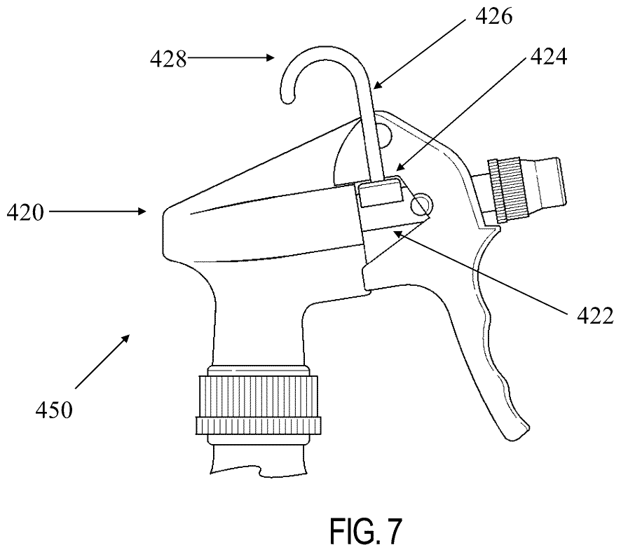

FIG. 7 shows a partial perspective side view of a spray bottle 450. This embodiment includes a sprayer head 420 with an open face and exposed mechanism 422. The middle clip 424 fits in between the exposed mechanism 422 and the top of the sprayer head 420. The neck member 426 may be divided into two parts, surrounding the top of the sprayer head 420, and may be clipped together above the sprayer head 420 to secure the attachment feature 428 in place. The two parts of the neck member may be clipped together by a fastener (not shown), which may take the form of a button fastener, a locking mechanism, a hole and beveled insert, or the like. The lack of a tight coupling in this embodiment also allows for the middle clip 424 to slide back and forth on the exposed mechanism 422 as may be desired by the user to change the positioning of the attachment feature along the axis represented by the top of the sprayer head 420.

The embodiment disclosed in FIG. 7 is similar to that of FIG. 2, but with an open face sprayer head 420 instead of closed. This embodiment may allow a detachable and secure hooking mechanism where the traditional sprayer head in FIG. 2 did not allow for the detachable aspect. This mechanism therefore may provide the advantages of sturdy attachment without the drawback of the permanent attachment feature 124 protruding from the top of the sprayer head 120 as disclosed in FIG. 2. The embodiment in FIG. 7 further allows for one-dimensional translation of the attachment feature 428 to provide flexibility in storage options to the user.

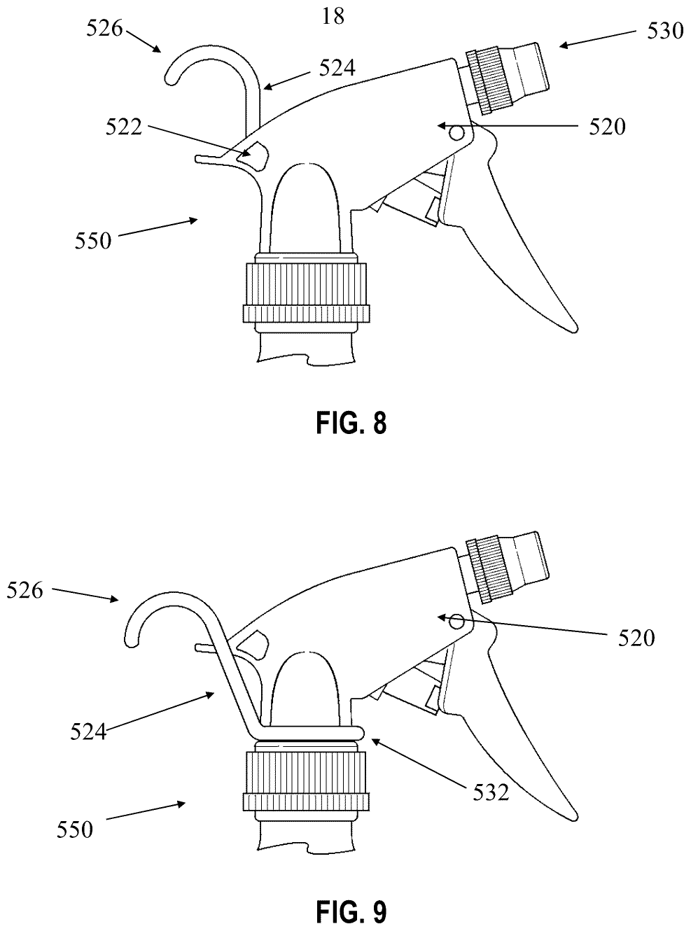

FIG. 8 shows a partial perspective side view of a spray bottle 550. This embodiment includes a sprayer head 520 with a locking mechanism (not shown) fitted into an aperture 522 in the back of the sprayer head 520. The locking mechanism is joined to a neck member 524 extending vertically from the aperture 522. The neck member 524 is joined to an attachment feature 526 from which the spray bottle 550 may hang. The locking mechanism, neck member 524, and attachment feature 526 all compose the same cohesive structure. Another variation on this embodiment can be for the locking mechanism to be replaced by a loose clip system with a plastic fastener similar to a zip tie.

Another example of the embodiment of FIG. 8 includes two circular recesses mirrored on either side of the rear portion of the sprayer head instead of the lone aperture 522 as is shown in FIG. 8. An attachment feature 526 with an arched neck and hook portion may attach at the two circular recesses by inserting two beveled protrusions (not shown) into the matching circular recesses. The beveled protrusions are held in place due to the construction of the attachment feature 526. The neck member 524 and attachment feature 526 portion form an inverted, curved rectangular trough (not shown) up to the apex of the curve of the hook portion. The beveled protrusions are attached to the walls (not shown), which tend to stay in place to keep the beveled protrusions pushed into the matching circular recesses such that the spray bottle will hang when held from the attachment feature 526. The attachment feature may hang where the base of the rectangular trough ends and the walls continue, creating a walrus-tooth end section (not shown) of the hook portion. The attachment feature 526 and neck member 524 may also be rotatable about the axis through the points where the beveled protrusions enter the matching circular recesses. This rotational movement may allow the device to rotate down and cover the top and front of the sprayer head 520. This aspect enables the spray bottle to take up no more space with the device attached than when it is detached, essentially removing any drawback to storage ability from other embodiments with protruding hooks. Because the attachment feature 526 also covers the front of the sprayer head 520, it may serve to prevent accidental spills and sprays of the fluid inside by accidental pressure on the trigger piece 528.

Yet another example of the embodiment of FIG. 8 includes a neck and hook member attached to the sprayer head 520 by attaching a circular protrusion (not shown) on one side of the sprayer head 520 composed of two semi-flexible semicircle-shaped pins (not shown) to a hole (not shown) of similar size in the base of the neck member 524 of the device. The device may maintain rotational ability at the point where the hole in the neck member 524 and the two semi-flexible semicircle-shaped pins meet. This rotational aspect may therefore allow the hook to rotate up and down along the side of the sprayer head 520, allowing for improved ease of storage. Because the device rotates down along the side of the sprayer head 520, it may take up minimally more space than when the device is not attached, thereby improving the capability of storage in modes other than hanging. Further, because the device rotates down along the side of the sprayer head 520, it may not block the nozzle 530 of the sprayer head 520. Therefore, the spray bottle may be used even when the device is in the collapsed position.

FIG. 9 shows a perspective side view of the spray bottle 550. This embodiment includes the sprayer head 520 with neck member 524 extending at an angle from and attached by a rounded ring fastener 532, similar to that disclosed in FIG. 1. The rounded ring fastener 532 may be secured around the base of the sprayer head 520. The neck member 524 extends from the rounded ring fastener 532 at an angle from about 15 degrees above the horizontal plane to about 75 degrees above the horizontal plane. Extending at an angle, the neck member connects the rounded ring fastener 532 to the attachment feature 526. This embodiment allows for the spray bottle to be hung at an angle as needed by the user.

The angular extension of the neck member 524 disclosed in FIG. 9 may permit a spray bottle to hang more closely to an opening on a wall. Because such a configuration would tend to leave the center of mass of the spray bottle to one side of the wall, the bottle would tend to press against the same wall to which the attachment feature 526 has been inserted. This may provide a more secure storage option by forcing the spray bottle 550 against the wall, instead of being held in place only by the weight of the bottle on the attachment feature 526.

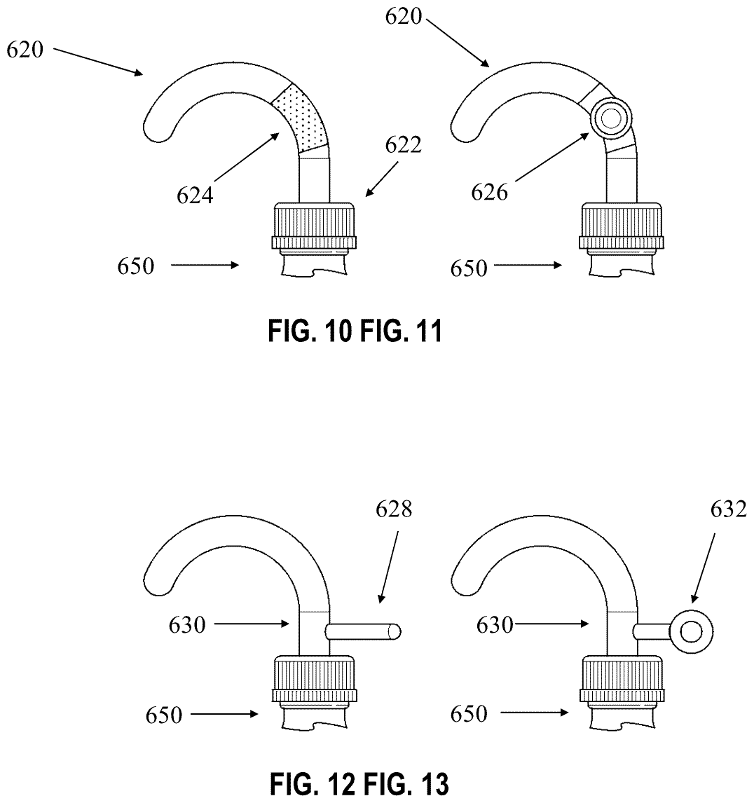

FIG. 10 shows a perspective side view of a bottle 650. This embodiment shows a bottle without a spray head attachment, and instead features an attachment feature 620 joined directly to a bottle cap 622 screwed onto a bottle 650 capable of holding liquid. This embodiment discloses an attachment feature 620 with an additional attachment mechanism of an adhesive portion 624 on the attachment feature 620. The adhesive portion 624 may be composed of any adhesive, such as a sticky substance or a magnet to attach more effectively to certain surfaces as needed by the user.

The inclusion of an adhesive portion 624 on the attachment feature 620 of the device as shown in FIG. 10 may provide more flexibility in storage options to the user. For example, the user may desire to hang the spray bottle on their refrigerator, but the refrigerator has no protrusions attached viable for hanging the attachment feature 620 when configured only as a hook. Instead, the adhesive portion 624 may be magnetic, and therefore the user may push the adhesive portion 624 up against the refrigerator, where it will stay until it is taken down again. The variety of possible adhesive technologies may permit any attachment feature disclosed in any of these embodiments to hang from many other surfaces.

FIG. 11 shows a perspective side view of a bottle 650. This embodiment shows the attachment feature 620 with an additional attachment mechanism of a suction cup portion 626 on the attachment feature 620. The suction cup portion 626 may be used to attach more effectively to certain surfaces as needed by the user.

The inclusion of a suction cup portion 626 on the attachment feature of the device as shown in FIG. 11 may provide more flexibility in storage options to the user. For example, the user may desire to hang the spray bottle on their shower wall, but there are no protrusions available within the shower which are viable for hanging the attachment feature. Instead, the user may push the suction cup portion 626 up against the glass or ceramic wall of the shower, where it will stay until it is taken down again.

FIG. 12 shows a perspective side view of a bottle 650. This embodiment shows the bottle 650 with an additional attachment mechanism of a leg member 628 protruding from the neck member 630. The leg member 628 could be cylindrical as seen in FIG. 12, or another shape as needed by the user.

The leg member 628 attached to the neck member 630 of the device as shown in FIG. 12 may allow for better storage capacity in some situations. For example, if the user wishes to store the device in a pegboard, a cylindrical leg member 628 may serve to keep the spray bottle in place on a pegboard into which the attachment feature 620 may not fit.

FIG. 13 shows a perspective side view of a bottle 650. This embodiment shows the bottle 650 with an additional hole attachment member 632 protruding from the neck member 630. The hole attachment member 632 may be round as shown in FIG. 13, or another shape as needed by the user.

The hole attachment member 632 serves to attach the device more easily to other hooks or wires. For example, if the user wants to attach another item to the spray bottle, they may tie a string around that item, then thread the string through the hole attachment member 632 and tie it there, so the other item remains attached to the spray bottle without interfering with hanging mechanism.

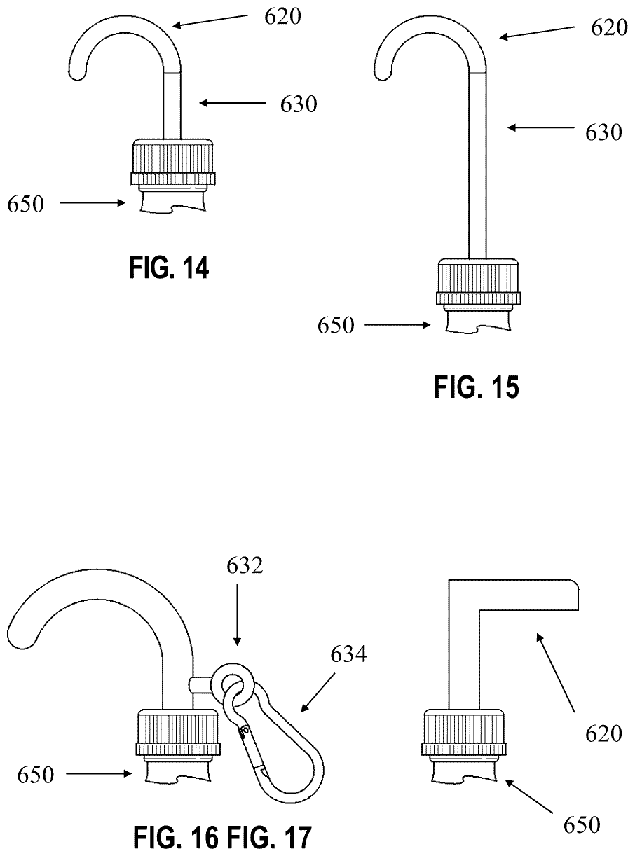

FIG. 14 shows a perspective side view of a bottle 650. This embodiment shows the bottle 650 with the attachment feature 620 attached to a shortened neck member 630. The shortened neck member 630 serves to accommodate instances where the user may desire for the bottle to hang higher than what can be accomplished by the standard neck length for storage purposes.

FIG. 15 shows a perspective side view of a bottle 650. This embodiment shows the bottle 650 with the attachment feature 620 attached to an extended neck member 630. The extended neck member 630 serves to accommodate instances where the user may desire the bottle to hang lower than what can be accomplished by the standard neck length for storage purposes.

FIG. 16 shows a perspective side view of a bottle 650. This embodiment demonstrates how the hole attachment member 632 may serve to connect with a carabiner or a similar clip 634 to better facilitate storage of spray devices during transport. The attachment of such a carabiner or similar clip 634 to the hole attachment member 632 may allow for easier and more secure connection to pieces of luggage during transport, such as connecting the spray bottle with the fabric loop of a zipper or other securing mechanism on a backpack.

FIG. 17 shows a perspective side view of a bottle 650. This embodiment shows an attachment feature 620 configured with a squared hook as opposed to the rounded hook member typical to an attachment feature 620. The square hook member configuration of the attachment feature 620 allows a spray device to hang from squared surfaces such as countertops and desks. If the user wishes to hang a spray bottle from a square surface, a rounded hook configuration of the attachment feature 620 may not properly secure the bottle 650 to the desired surface, instead allowing the body (not shown) of the bottle 650 to push against the surface and losing grip due to the limited amount of surface area of the rounded hook configuration of the attachment feature 620 touching the surface. If instead the square hook configuration of the attachment feature 620 is used, the increased surface area that touches the surface may serve to better secure the spray bottle.

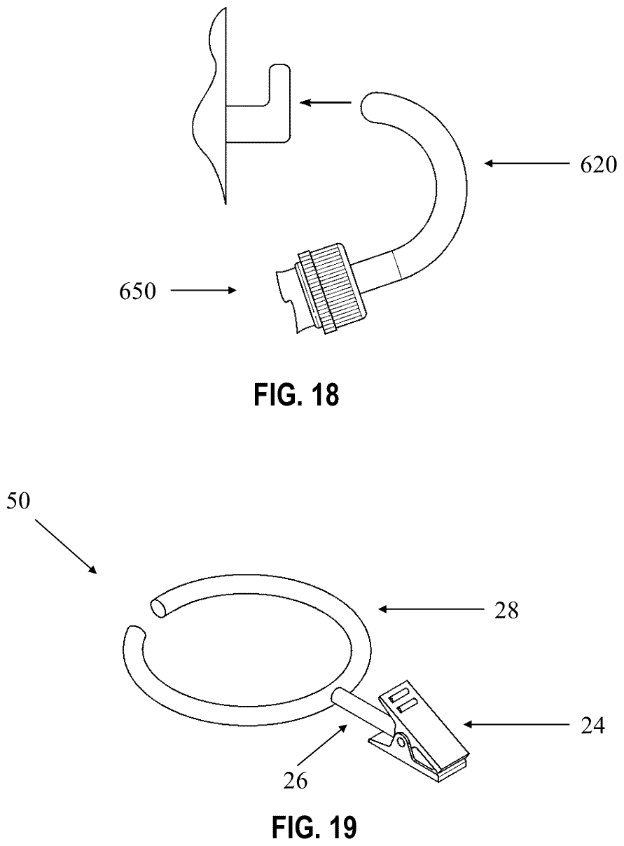

FIG. 18 shows a perspective side view of a portion of a bottle 650. This embodiment employs the use of magnets to change configurations depending on the status of contact with the device. The structure of the magnets within the attachment feature 620 ensures that when the attachment feature 620 is in the straight configuration, the configuration of the magnets within the attachment feature 620 maintain a rigid structure. However, when a force is applied to the side of the attachment feature 620 in the straight configuration, the attachment feature may collapse into a rounded configuration. In the rounded configuration, the attachment feature 620 may cling to the surface by encompassing it and magnetically latching to itself. This capability allows the attachment feature 620 to have a variable radius with which it may attach to a surface. This variable radius feature is a valuable feature for the device, allowing the bottle to be hung from a wide variety of surfaces, with wide ranges of radius to which the attachment feature 620 could hang. The magnets in the attachment feature 620 may also be advantageous by providing an inherent latching mechanism such that the attachment feature 620 can be successfully attached to any surface with a radius less than the length of the attachment feature 620.

FIG. 19 shows a perspective side view of a portion of a spray bottle 50. This embodiment discloses a rounded ring fastener 28 configured to attach around the skirt portion (not shown) of a spray bottle 50 by a rounded ring fastener 28, and an attachment feature 24 configured to a crocodile fabric clip embodiment attached to the neck member 26. The crocodile fabric clip configuration of the attachment feature 24 serves to allow the spray bottle to hang from fabric if so desired by the user.

What is claimed is:

1. A spray bottle hanging device comprising:
a hook member configurable to attach a spray bottle to a desired object;
a neck member configurable to provide space between the hook member and the spray bottle; and
a fastener configurable to couple the spray bottle hanging device to the spray bottle.

2. The spray bottle hanging device of claim 1, wherein the fastener is a rounded ring fastener including a connector portion, wherein the connector portion is configurable to couple to the neck member, the rounded ring fastener further comprising:
a clip button fastener configurable to tighten and lock the rounded ring fastener in place.

3. The spray bottle hanging device of claim 2, wherein the neck member extends at an angle from the rounded ring fastener.

4. The spray bottle hanging device of claim 1, wherein the spray bottle comprises a sprayer head and a sprayer mechanism, wherein:
the sprayer head comprises a gap such that the neck member fits into the gap and attaches within the sprayer mechanism.

5. The spray bottle hanging device of claim 1, wherein the hook member is rotatable to accommodate varying hanging positions.

6. The spray bottle hanging device of claim 1, wherein the hook member comprises an elongated spray trigger.

7. The spray bottle hanging device of claim 1, wherein the spray bottle comprises a sprayer head, wherein the fastener comprises a strut clip configurable such that the strut clip straddles the sprayer head and enters a recess of the sprayer head.

8. The spray bottle hanging device of claim 1, wherein:
the hook member comprises a shark fin hook configuration; and
the fastener comprises a body configurable to secure the spray bottle hanging device to a nozzle of the spray bottle.

9. The spray bottle hanging device of claim 8, wherein the hook member is detachable and rotatable.

10. The spray bottle hanging device of claim 1, wherein the spray bottle comprises a sprayer head, wherein the sprayer head has an open face and exposed mechanism such that:
the fastener fits between the exposed mechanism of the sprayer head and the top of the sprayer head;
the neck member comprises two parts configured to be clipped together above the sprayer head to secure the hook member; and
the two parts of the neck member are secured by a fastener.

11. The spray bottle hanging device of claim 10, wherein the spray bottle hanging device is detachable from the spray bottle.

12. The spray bottle hanging device of claim 1, wherein:
the fastener comprises a locking mechanism fitted to an aperture in a back of a head of the spray bottle;
the neck member is joined to the fastener and extends vertically from the aperture; and
the hook member is joined to the neck member.

13. The spray bottle hanging device of claim 1, wherein:
the fastener comprises a loose clip system with a plastic fastener configured to attach to an aperture in a back of a head of the spray bottle;
the neck member is joined to the fastener and extends vertically from the aperture; and
the hook member is joined to the neck member.

14. The spray bottle hanging device of claim 1, wherein:
a rear portion of a head of the spray bottle comprises two circular recesses on either side;
the fastener comprises two beveled protrusions matching the two circular recesses; and
the fastener is attached to the neck member configured to hold the fastener in place.

15. The spray bottle hanging device of claim 13, wherein the spray bottle hanging device is rotatable about an axis through points where the two beveled protrusions enter the two circular recesses.

16. The spray bottle hanging device of claim 1, wherein:
the fastener comprises a circular protrusion on one side of a head of the spray bottle, including one or more semi-flexible pins attached to a hole of similar size in a base of a neck member of the spray bottle hanging device.

17. A bottle hanging device comprising:
a hook member configurable to attach a bottle to a desired object;
a neck member configurable to provide space between the hook member and the bottle; and
a fastener joined to a bottle cap configurable to couple the bottle hanging device to the bottle.

18. The bottle hanging device of claim 17, further comprising an additional attachment mechanism selected from the group consisting of an adhesive portion, a suction cup portion, a magnetic portion, a leg member, and a hole member.

19. The bottle hanging device of claim 17, wherein the hook member is a square hook configurable to allow a bottle to hang from squared surfaces.

20. The bottle hanging device of claim 17, wherein the hook member and neck member comprise magnets such that the bottle hanging device can change configuration depending on the status of contact with the bottle hanging device.
